(19) United States
(12) Patent Application Publication
(10) Pub. No.: US 2005/0209992 A1
(43) Pub. Date: Sep. 22, 2005

(54) Method and system for search engine enhancement

(76) Inventors: Dan Kikinis, Saratoga, CA (US); Gene Feroglia, Los Altos, CA (US)

Correspondence Address: John P. Ward;BLAKELY, SOKOLOFF, TAYLOR & zAFMAN LLP, 7th Floor, 12400 Wilshire Boulevard, Los Angeles, CA, 90025, US

(21) Appl. No.: 11/035,280

(22) Filed: Jan. 12, 2005

Related U.S. Application Data
(60) Provisional application No. 60/536,142, filed on Jan. 12, 2004.

(51) Int. Cl. G06F 7/00

(52) U.S. Cl. 707/1

(57) ABSTRACT

A method and a system for search enhancement that can deal with semantic differences in a manner that does not require the user to have a PhD in search or in linguistics. Furthermore, extended, semi-automatic use of synonyms of related terms is necessary to avoid interaction with an ontological tree, as is typically presented by large search portals on the public Internet. Using a common Thesaurus as a basis; which improves over time based upon collective use is one of the novel elements in this approach. In addition, a user friendly navigation schema for easily exposing where to go for a particular result is mandatory. Furthermore, it is desirable, that such interface be intuitive to use, and not require lengthy training for fast and effective use.

### RELATED APPLICATIONS

This application claims the benefit of Provisional Application No. 60/536,142, entitled “Method and System for Search Engine Enhancement,” filed Jan. 12, 2004 (Attorney Docket No. 6875.P002Z) and is incorporated herein by reference.

### BACKGROUND

Search engines have become increasingly important for searching the Internet for information. Although a vast amount of information is available on the Internet, it is often hard to find. Increasingly, information that a person seeks is drowned in a lot of “noise,” i.e., irrelevant results, such as advertising-sponsored results that may not be exactly what the person is looking for and other clutter Semantic interpretation of search terms has been researched for quite some time. Other approaches to accelerate the search effectiveness have included natural language processing, automatic search term expansion and a multitude of algorithms, as well as other methods. However, all of these approaches have failed to produce better search results for a variety of reasons. We believe the combination of a sophisticated semantic approach based on a unified thesaurus combined with an intuitive user interface will provide the searching community a more favorable result in a more timely manner and thus a much more satisfying experience searching.

### BRIEF DESCRIPTION OF THE DRAWINGS

FIG. 1 shows an overview of a search system in accordance with one embodiment;

FIG. 2 shows in more detail how software instance interacts with the system in accordance with one embodiment;

FIG. 3 shows a screen as it could appear, according to the preferred embodiment of the novel art of this disclosure in accordance with one embodiment;

FIG. 3b shows an example of a “cookie crumb” bar in accordance with one embodiment;

FIG. 4 shows a blow-up of the basic two-ring hexagonal structure for normal users in accordance with one embodiment;

FIG. 4a shows an example of the results in window of a consultation with a dictionary server such as server in accordance with one embodiment; and

FIG. 5 shows the unpopulated cells are grayed out, while the populated cells are filled out in various colors in accordance with one embodiment.

### DETAILED DESCRIPTION OF THE INVENTION

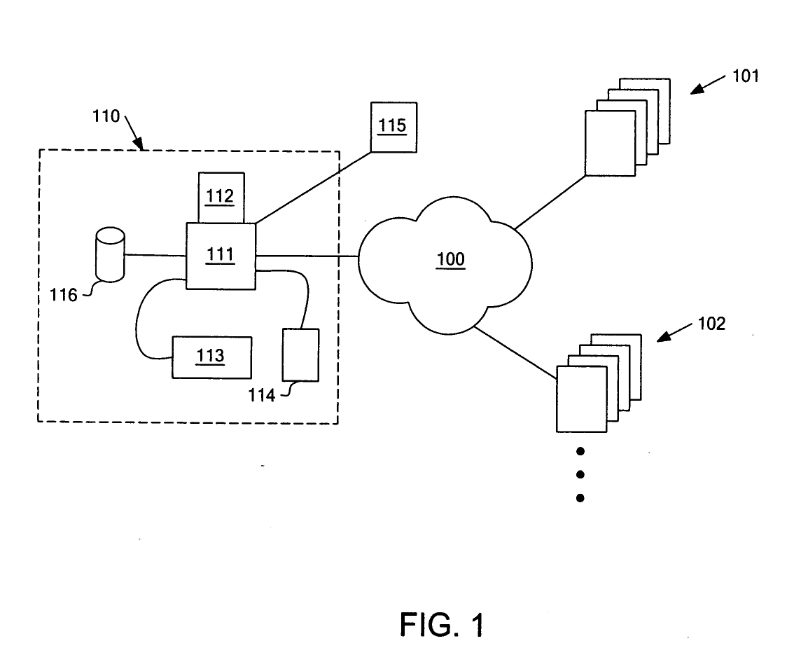

FIG. 1 shows an overview of a search system. Internet 100 is connected to several search services/engines, including, as shown in FIG. 1, search service 101 and search service 102, each of which has billions of information items. Connected to the Internet is a client device 111 in a user's office or home location 110. Elements of the client device 111 may include, but are not limited to, a monitor 112, a local storage 116, a pointing device 114 (such as a mouse, trackball, or other similar device), a television, a phone (cellular or other), a mobile navigation device (such as those found in automobiles, planes, boats, etc,) and an input device 113 such as, but not limited to, a keyboard, a mouse, or any other useful pointing device, including such as used on so-called “tablet PCs” or equivalent devices, also including gloves or even voice recognition software, etc. Also shown is a software instance 115 of the novel art of this disclosure.

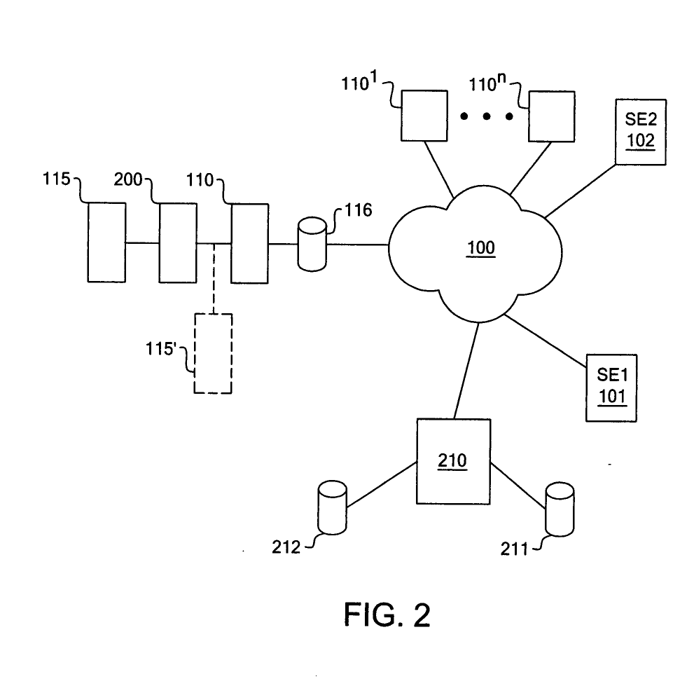

FIG. 2 shows in more detail how software instance 115 interacts with the system. Client device 111 contains a web browser 200. Software instance 115 may be plugged into or executed completely within the browser 200 as is shown in FIG. 1, or in some cases it may be similar to a hidden proxy 115′ behind the browser. Any combination or variation of these two scenarios may be possible without departing from the spirit of the novel art of this disclosure. Also shown again is Internet 100. It is clear that any of many variations of connection between device 111 and Internet 100 may be used, including but not limited to wireless, wired, satellite, or infrared links. Furthermore, it does not matter whether client device 111 is a personal computer or workstation, a mobile device such as a cell phone or pocket PC. Local storage 116 may be a hard disk or some other form of nonvolatile memory, such as a SmartCard, optical disk, etc.

In addition to search engines SE1 101 and SE2 102, also shown is server system 210, which allows the user to download the application 115 or 115′. System 210 has two storage areas 211 and 212.

Storage area 211 contains applications for download to various devices and also dictionaries and thesauri with semantic synonym relationship tables, allowing application 115 or 115′ to look up broader, narrower, related, or synonym terms, as described in greater detail below. There may be a variety of downloads available, such as for web phones or other portable devices, or Apple computers and other non-Windows operating systems, such as Linux, Unix, etc.

Storage 212 may be used to store a user's personal information. Personal information would include, but not be limited to, a person's search criteria, history or favorite search terms, recent searches, industry or category-specific data (tied to special area of interest searches), stored navigation paths within the thesaurus data, personal additions to the thesaurus, etc. Depending on the system, in some cases personal information may be stored on local storage 116, while in other cases an account may be established permitting information to be stored on server storage 212. In some cases, an enterprise server (not shown) may provide proprietary storage inside the boundaries of an intranet for employees and contractors of an enterprise, for example, or government agencies, etc. The advantages of storing information on a server may be that if the user searches from a variety of different client devices 111, the user can always have his personal information available. Server 210 as shown in this embodiment may in some cases be a public service operated by a provider, while in other cases it may be an enterprise-wide server behind an enterprise firewall on a virtual private network. Also, search engines 101 and 102 may in some cases be public sites, for example, while in other cases they may be private network search engines on an enterprise intranet, or subscription search engines such as legal, medical, or other specialized areas.

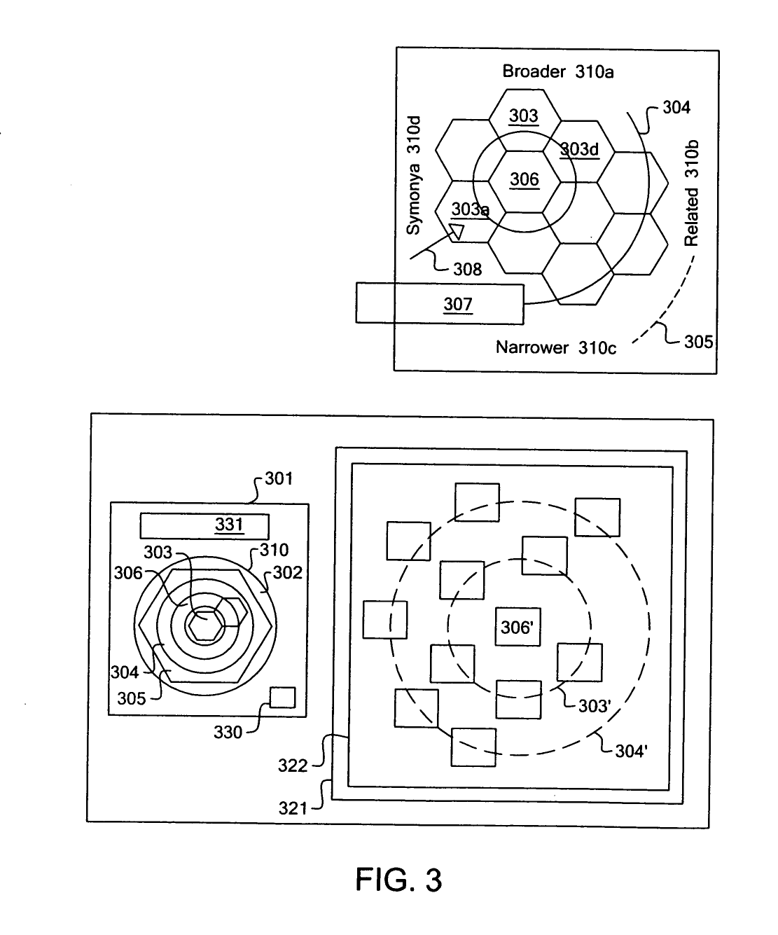

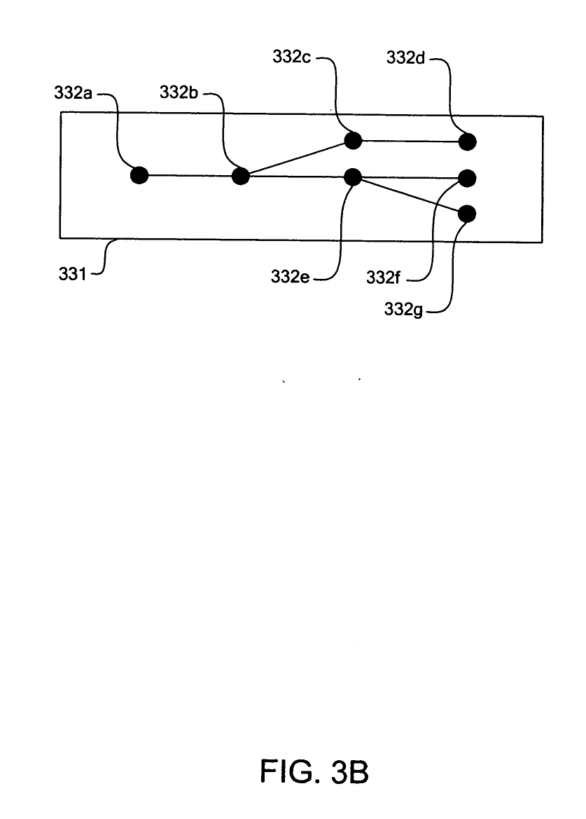

FIG. 3 shows a screen as it could appear, according to one embodiment of the novel art of this disclosure. Two major components are shown: navigation control window 301 and information display (search result) window 321.

Window 301 contains several novel elements. One element is a polygon-shaped form 302, with a hexagonal-shaped embodiment shown here, containing a variety of cells. The cells could be in the form of a circle or could have any combination of sides, numbering three or larger. Some of these cells may be colored. At the center of the hexagonal array 302 is cell 306, where the initial search term is entered. At the top of the window is a “cookie crumb” bar 331, which allows the user to navigate among multiple paths of current searches. This feature is discussed in greater detail below.

The user may enter a search term in center cell 306 or in a text box that appears above, in front of, or instead of form 302 at the initial entry into the system. Application 115 or 115′ then consults server 210 and its associated dictionary 211, and the results are then populated into the cells of the polygon structure 302, as described in greater detail in the discussion below. It is clear that the server for the dictionary search need not be the same server on which the user information is stored, and in fact, it may be at a different location. Further, in some instances, for example in an enterprise environment, an additional local, private dictionary server may be used in addition to or instead of the dictionary server shown in FIG. 3.

Also available is a button 330 that allows the user to send the entire search to another party. If the destination party does not have software instance 115 installed, the send function offers a link to download software instance 115 and store it and then make the search available.

Each cell offers the opportunity to zoom in for a more detailed slice of the resulting data. This capability can be expanded and would be extremely useful to researchers and others. There can be further rings (i.e., 305, etc.), and large displays would easily support five or ten rings, or even more. Also, partial transparent multiple planes of the honeycomb could be in 3-D and thus open up more and deeper opportunities for displaying results. They could, for example, be assigned to different search engines, archives etc.

As the user moves from ring to ring or from side to side or plane to plane he maybe presented with a password for security purposes. For example, in the Mustang example described below, a user could hit a Ford Zone requiring a password to get in. And then within that area the original BOM may be presented, which could require yet another password. Further, payment may be required, which could be managed by either having a subscription to a for-fee database, or allowing a micropayment mechanism (not shown) to reside in software instance 115. Such systems would make allowances for the fluidity of databases (both public and private, free and for fee) over time. Passwords may be prompted for in the usual manner, or may be stored in either a common password vault, such as Microsoft™ Passport™, or in a proprietary system (not shown) integrated in software instance 115, and stored along with other personal data as described above.

Also, importantly, multi-lingual support may be added, offering multiple language dictionaries, thesauri and other tools (i.e., spell checking), allowing performance of multilingual searches.

In yet other aspects, spell checking may be offered at the entry window, either single language, or multi lingual. Further, tracking mechanisms may be included, both on personal and system levels, allowing the software to track the success of searches and dynamic refinement of both personal and public dictionaries and thesauri. Public statistics may also be used to optimize sponsorship of ads, which may be added in some instances, for example, to the basic free service. Lastly, tracking may also be used for billing purposes in case of “buyers lead” agreements, where searches result in commercial activity, either directly with a merchant, or by a sharing agreement in the commission paid to the underlying search engine used.

One embodiment includes the colors, textures, font changes, 3-D hints, and the unconscious (subliminal) queues used to navigate visually through the semantic map of the clusters of documents derived from the data collections (search engines and databases). Also, sound or background music may be added to add to the subliminal effects of intuitively enhanced search.

Around center element 306, cells that contain terms are arranged in rings. Terms in rings close to the center are closer in semantic meaning to the center element term 306. Terms in rings farther away from the center term are further away in semantic meaning from the central search term. There may be different numbers of rings, depending on the type of search and individual searching. For example, a professional searcher or experienced individual may enable the display of five or six rings, expanding the visual cache and breadth of search coverage (recall), while for public, generalized, precision-oriented searches, there may be only one or two rings.

Also, not all polygons may be filled. Those that are not filled may be grayed out (unavailable), while those that are filled may be colored to indicate semantic relationships among the terms. The color saturation of cells indicates the density (number and size of document clusters) with close semantic meaning to the search term. The color mixture of the cells indicates the semantic relationship of the term within the central white cell to the term within the colored cell. Green corresponds to broader terms; blue is for synonyms; red is for narrower terms. Cell colors of the terms are a mixture based on the relative strength of the thesaurus relationships to the white central term. For example, the amount of “synonymity” (sameness) between the central term and a given term determines the amount of blue in its color. The term's specificity to distinguish among document clusters (narrowness) determines the amount of red in its color. Therefore a purple term is both narrower and synonymous and the exact color mixture is based on the combination and strength of these attributes. Because of the small number of different thesaurus relationships and large number of different color possibilities, the user of this system quickly and subliminally grasps the relationship or association between the term in a colored cell and the central term. The darkness of the font of the term reflects the confidence in the term's placement and its specificity to the current relationship. Frequent, non-specific terms that may veer off into other clusters of the collection semantically unrelated are thinner; more specific and discriminating terms are bolder.

The relationship ring 310 outside search rings 303 and 304 contains words describing the semantic relationships of the resulting terms to the original term. In the exploded detail included in FIG. 3, the words describing relationships of the elements are, for example, Broader 310a (top), Narrower 310c (bottom), Synonym 310d, and Related Terms 310b.

Because the terms themselves are derived from document clusters, the system exposes language (search terms) and therefore also areas of the search engine or database that the user would not ordinarily uncover. The coloring, including mixture, hue, and saturation of these terms, enables a subliminal, intuitive navigation to new and expanded search terms that in turn enable finding the desired results in the underlying search engine or database.

It is possible to map these term relationships to sounds in addition to or instead of colors. For a blind person or for telephone retrieval (including cell phones), as well as tv program guides, the sound and tone of a background music added or of the voice speaking each search term can correspond to the term's relationship to the central term. And, since there are so few relationships, the telephone keypad could be mapped to the corresponding navigation paths—2 could correspond to broader; 4 corresponds to synonyms; 6 is for related terms; 8 is for narrower. The other numbers are similarly a mixture of the types of relationship. So 1 would be both broader and synonymous; 3 would be both broader and related; 7 could be both narrower and synonymous, and 9 is both related and narrower. Color saturation, hue, and exact color mixture would correspond to corresponding aspects of the voice reading the term.

The term relationships are derived from clusters of documents within the back-end search systems, not from a “pure” linguistic definition of the words and phrases composing the search terms. The search terms may appear to have widely varying linguistic meaning in a pure natural language sense; semantic document similarities of groups of documents that are similar to the top matches of the original search terms are used to derive terms that discriminate a different group of documents. The terms displayed in the surrounding rings discriminate these new groups (clusters) of documents, which would otherwise not be included as the result of searches from the original vocabulary of the search terms or as related to the documents the original terms retrieve. These clusters can be automatically derived.

The hexagon structure 302 has white cells in the center and highly saturated color in the farthest cells. The colors are arranged in a color circle. Depending on the search result, the colors may be compressed or expanded to represent the narrower or wider availability of related terms.

As the user moves a cursor 308 over a cell, for example cell 303a, a popup 307 appears that displays a large, easily readable display of the search term in cell 303a, at least two hexes away, so that the user can always navigate out of the selected hex. By clicking on a cell, the user can choose to move the term within the cell into the center position 306 and restart the whole range of searches. For each cell that contains a term a search is commissioned on a search engine and the results are displayed in overlay 322. These overlays may use different levels of transparency, allowing the underlying thumbnails to appear almost like watermarks. Special zoom in-out effects may be used to make the appearance visually more pleasant, as well as enhanced by some sound effects The results are represented by little thumbnail windows, such as, for example, thumbnail 306′ representing the search for the term in center 306, with ring 303′ containing up to six thumbnail windows and likewise ring 304′ containing corresponding thumbnails, etc.

As the cursor moves over a term, as shown in the expanded detail, not only does popup 307 appear, but also an overlay 322 overlaying the thumbnails with an 80 percent screen, so the thumbnails appear only as slight shadows, and window 322 shows the unmodified search results as delivered from the search engine(s).

In some cases, multiple engines may be used in one search; while in other cases, multiple hexagonal structures 302 may exist in different planes that may be navigated using a scroll bar on the right side of the window (not shown). By navigating among various hexagonal structures 302, different windows 322 would appear that contain the results of different search engines. For example, in a professional search environment in an enterprise, the first two layers may be two different intranet search engines. The other layers may then represent public search engines, or specialized search engines, such as for example, the United States Patent and Trademark Office search engine.

FIG. 3b shows an example of a “cookie crumb” bar 331. In this example, the initial crumb (node) 332a led to another crumb 332b, which then branched out to crumbs 332c and 332d. The user was not happy with the results, and clicked on crumb 332b, starting a new branch in a different direction to crumb 332e. As he went on to crumb 332f, he didn't like the results. He then went back to crumb 332e and sidetracked to crumb 332g. The difference between the historical or back and forward navigation offered in browsers known in current art and the novel art of this disclosure is that with bar 331, the user can quickly move from one search branch to another; whereas in current art, once you go back and start in a new direction, the old direction is no longer available in your branch and is much more difficult to find in the history. Again, as an option in bar 331, each of the crumbs, when moved over with a cursor, may open a bubble showing the search term associated with that particular crumb. And moving the cursor over that term causes the associated window with results to change, reflecting the results of queries to the search engine(s). Other techniques may be used instead of cookie crumbs, such as drop down menu-lists, etc., as long as they allow a multi-linear history retrace.

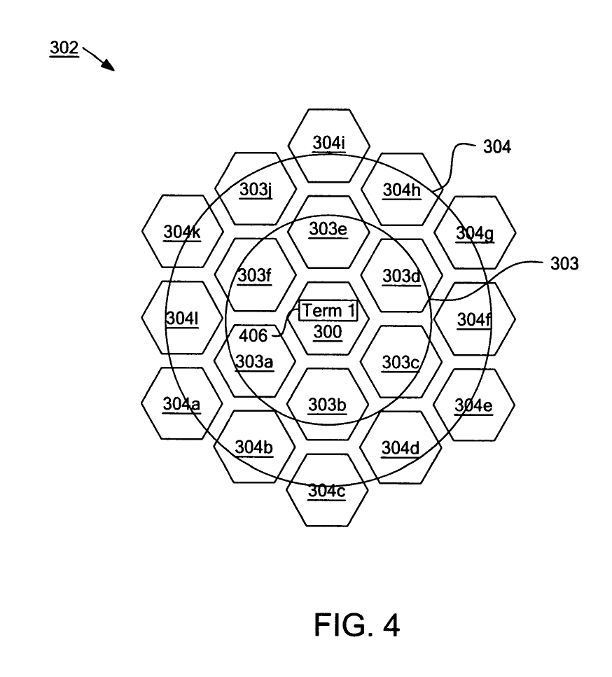

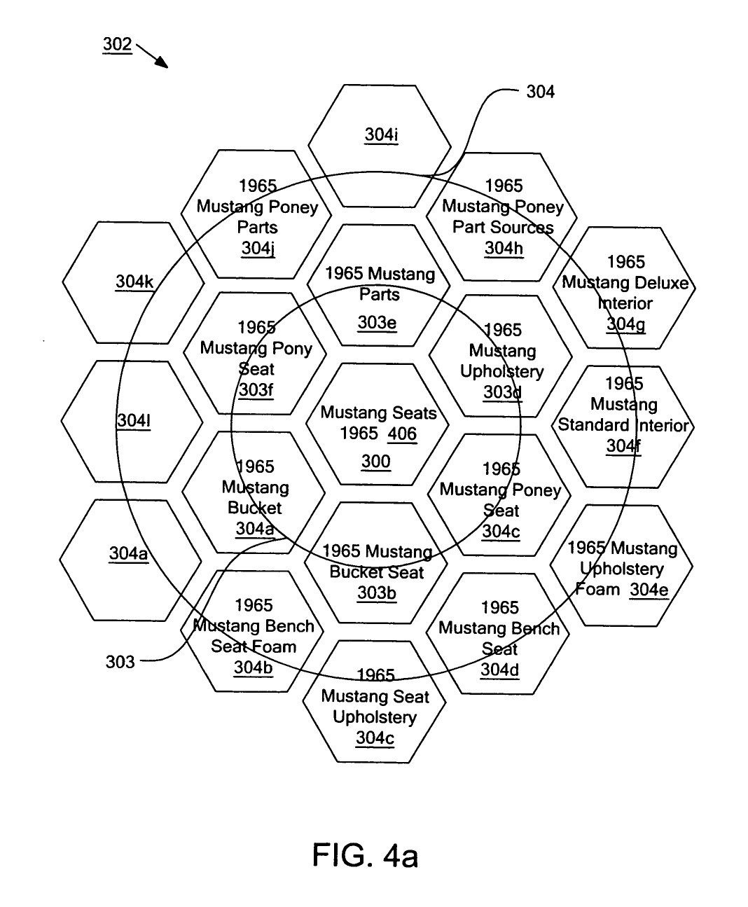

FIG. 4 shows a blow-up of the basic two-ring hexagonal structure for normal users. At the center is cell 306, showing the original search term, then related terms are shown around it. The farther away the rings are from the center, the more saturated their color becomes.

FIG. 4a shows an example of the results in window 301 of a consultation with a dictionary server such as server 210.

In this example history, 17-year-old Jimmy has a restored 1965 Ford Mustang in need of new seats. Jimmy and his father go to a search engine search site on the Internet and type in “1965 mustang seats,” but they find no seats for sale. They try queries such as “1965 mustang seats for sale,” “1965 ford mustang seats,” “1965 mustang horse emblem seat” but cannot find what they want—the pony deluxe seats that have the horse emblem on them. But then the father opens an email message from his brother with a link to the search assistant software instance 115. He clicks on the link, downloads, and then starts the application.

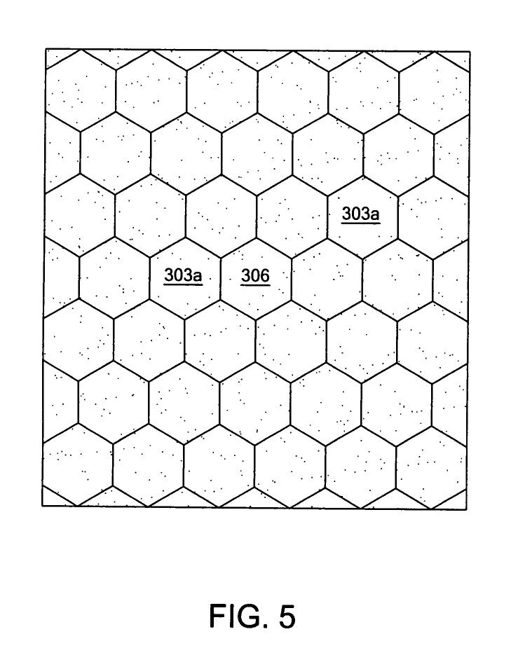

He enters search term 406, which is “1965 Mustang seats,” and as shown in FIG. 4a, various cells around the center are populated, although not all cells. The unpopulated cells are grayed out, while the populated cells are filled out in various colors, as shown in the color pattern in FIG. 5. FIG. 5 shows more than two rings, but the embodiment shown in FIG. 5 is a variation that is within the spirit and scope of the novel art of this disclosure.

In FIG. 4a, to the left are synonyms such as 1965 mustang pony seat, 1965 mustang bucket.

To the right are related terms, including 1965 mustang upholstery, 1965 mustang pony seat, 1965 mustang deluxe interior, 1965 mustang standard interior, and 1965 mustang upholstery.

Below are narrower terms, such as 1965 mustang bucket seat, 1965 mustang bench seat, 1965 mustang seat foam, and 1965 mustang seat upholstery.

Above are broader terms, including 1965 mustang parts, 1965 mustang pony parts, and 1965 mustang pony part sources.

At the same time as the control window 301 morphs from text entry to the color hex map, window 321 opens with thumbnails of results pages. The thumbnails are arranged and colored to correspond to their respective terms in window 301. Inside each is a very small results page, truncated to the top five results. At the top of the second window is the result for “1965 mustang seat” with white background, again truncated to five results.

Jimmy's dad navigates from the center, to the right, clicking on “1965 mustang pony seat”. He clicks on the first and fourth results, which provide a selection to purchase the seats.

Other geometric shapes may be used instead of hexagons, such as squares, octagons, triangles etc. providing for more directionality. Also, gray shades or texture may be used instead or additionally to color. Sound may be used to enhance the subliminal effect, by changing the tune according to the area the cursor hovers above etc.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1) A method comprising:
in response to receiving a first search phrase, providing search enhancement by providing one or more separate search phrases prior to a search.

2) The method of claim 1, wherein the search enhancement includes offering one or more separate words based on semantics of one or more words of the search phrase.

3) The method of claim 1, wherein the search enhancement includes offering one or more separate words based on thesaurus relation of one or more words of the search phrase.

4) The method of claim 1, wherein the search phrase includes multiple words.

5) The method of claim 1, wherein the search enhancement further include providing visual cues to assist in navigating to one or more separate search phrases.

6) The method of claim 5, wherein the visual cues include one or more of a color component, font sizes, and textures.

7) The method of claim 1, wherein the search enhancement further includes providing audio cues to assist in navigating to one or more separate search phrases.

8) The method of claim 1 wherein the search enhancement further includes providing one or more separate search phrases organized to present at least two from a group comprising of synonyms of the search phrase, related terms of the search phrase, one or more search phrases broader than the first search phrase, and one or more search phrases more narrow than the first search phrase.

9) The method of claim 1 wherein the search enhancement further includes providing the search enhancement of one or more separate search phrase in one of a polygon interface and a list.

10) The method of claim 1, further including revealing results of one of the separate search phrases in response to placing a cursor over one of the separate search phrases for a predetermined period of time without clicking.

11) The method of claim 1, further comprising providing one or more advertisements related to one or more terms of the first search phrase.

12) The method of claim 1, further comprising providing one or more advertisements related to one or more terms of the first search phrase and not keywords of a search.

13) The method of claim 10, further comprising providing one or more advertisements related to a separate search phrase having a cursor placed over the separate search phrase.

14) The method of claim 1, wherein the providing search enhancement by providing one or more separate search phrases prior to a search includes providing the search enhancement on one of a mobile device, a personal computer, and a television.

15) The method of claim 14, further comprising receiving the search phrase via an audible input.

16) The method of claim 1, wherein the one or more separate search phrases are accessed from a dynamic self-learning thesaurus.

17) The method of claim 16, further includes expanding the dynamic self-learning thesaurus by at least one of identifying connections among search terms or phrases by tracing click-throughs, and adding terms via crawling publications.

18) The method of claim 9, further comprising in response to selection of a trigger, toggling between the polygon interface and showing search results.

19) A system comprising:
a means for providing search enhancement, in response to receiving a first search phrase, by providing one or more separate search phrases prior to a search.

20) A machine-readable medium having stored thereon a set of instructions which when executed perform a method comprising:
in response to receiving a first search phrase, providing search enhancement by providing one or more separate search phrases prior to a search.
